(19) United States
(12) Patent Application Publication
(10) Pub. No.: US 2010/0272862 A1
(43) Pub. Date: Oct. 28, 2010

(54) PULVEROUS FORMULATION OF A FAT-SOLUBLE ACTIVE INGREDIENT

(75) Inventors: Thomas Lindemann, Bad Sackingen (DE); Karl Manfred Voelker, Freiburg (DE)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V.

(21) Appl. No.: 12/746,286

(22) PCT Filed: Dec. 4, 2008
(86) PCT No.: PCT/EP08/10255

§ 371 Date: Jun. 4, 2010

(30) Foreign Application Priority Data
Dec. 5, 2007 (EP) 07023505.6

(51) Int. Cl. A23L 1/035; A23L 1/303; A23L 1/302; A23L 1/0522; A23L 2/02; A23L 2/56; A23L 2/58

(52) U.S. Cl. 426/73; 426/98; 426/72

(57) ABSTRACT

(Finely divided) pulverous formulation of one or more fat-soluble active ingredients comprising modified food starch and one or more components chosen from the group consisting of polyglycerol esters and food composition, especially a beverage, containing said formulation.

The present invention relates to a dry (finely divided) pulverous formulation of one or more fat-soluble active ingredients, furthermore the invention relates to a food composition, especially a beverage, containing said formulation.

As used herein, the term “fat-soluble active ingredient” refers to vitamins selected from the group consisting of vitamin A, D, E, K and derivatives thereof; carotenoids; polyunsaturated fatty acids and flavoring or aroma substances as well as mixtures thereof. Preferred examples for polyunsaturated fatty acids are e.g. linoleic acid, linolenic acid, arachidonic acid, docosahexaenic acid, eicosapentaenic acid and the like. Preferred fat-soluble active ingredients are carotenoids, especially beta-carotene, lycopene, lutein, bixin, astaxanthin, apocarotenal, beta-apo-8′-carotenal, beta-apo-12′-carotenal, canthaxanthin, cryptoxanthin, citranaxanthin and zeaxanthin. Especially preferred is beta-carotene.

Processes for encapsulating fat-soluble active ingredients are well known in the art. One well suited method to protect a sensitive active and to achieve and maintain simultaneously bioavailability, and—if desired—a high coloring strength (in case of e.g. carotenoids) is to formulate an active ingredient in form of a so-called “beadlet”.

The term “beadlet” as used herein refers to small discrete particles, which have a mean particle size of 50-1000 μm in diameter and are usually nearly spherical. Beadlets contain one or more active ingredients in an encapsulated form.

Beadlets are obtained when an emulsion or suspension consisting of small lipophilic droplets of an active ingredient with a droplet size in the range of from about 1 to about 1000 nm dispersed in an aqueous matrix phase, is dried. The lipophilic droplets and/or the matrix can contain further ingredients, like antioxidants, plasticizers, and emulsifiers.

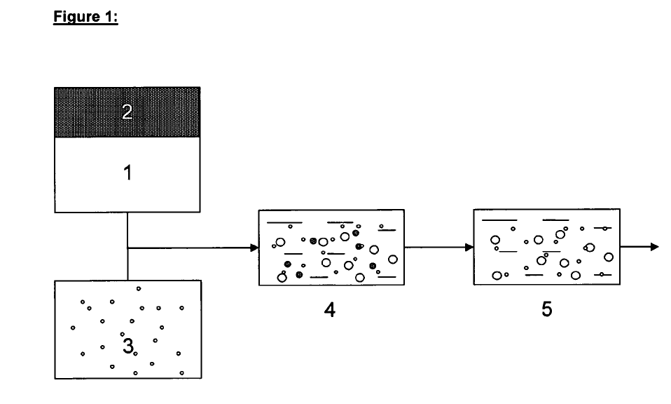

FIG. 1 shows a part of a common process for the preparation of a pulverous (beadlet) formulation of a fat-soluble active ingredient as described e.g. in EP-937 412-A1: A so-called pre-emulsion (4) is made from an oil phase containing in addition to the active ingredient one or more oils (1) and one or more solvents (2) and an aqueous (matrix) phase (3) containing a swellable colloid. Removal of the solvent leads to the solvent-free (ready-to-dry-) emulsion (5), which may then be dried by a standard process thereby deriving a pulverous formulation.

The beadlets are formed during a drying step, i.e. beadlets are solid and contain small lipophilic droplets with the active ingredient embedded in a matrix formed of solid components, whereby the lipophilic droplets are homogeneously distributed in the matrix. The typical size of the lipophilic droplets in the matrix is in the range of from about 1 to about 1000 nm, preferably from about 150 to about 400 nm, more preferred from about 200 to about 300 nm.

The drying step may be carried out with any conventional drying process known to the person skilled in the art and at any reasonable temperature. Heating to about 40 to 60° C. is preferable.

Preferred are spray drying and/or a powder catch process where sprayed suspension droplets are caught in a bed of an absorbant such as starch or calcium silicate or silicic acid or calcium carbonate or mixtures thereof and subsequently dried. If a powder catch process is applied, the beadlets further contain a layer of the capturing media on the surface. This layer leads to a rough surface of the beadlets. The capturing media is often starch, silicates or phosphates.

If the beadlets are dispersed in water, the components of the matrix are dissolved, whereas the lipophilic droplets with the active ingredient remain unchanged, i.e., the original emulsion or suspension with its small particle size (from about 1 to about 1000 nm, preferably from about 150 to about 400 nm, more preferred from about 200 to about 300 nm) is reconstituted. The high bioavailability and coloring strength of a nano-emulsion or nano-suspension is therefore maintained.

Emulsifying agents are necessary during the preparation of an emulsion/suspension in order to lower the interface tension between the lipophilic active ingredient and the aqueous matrix. After formation of the emulsion/suspension the emulsifying agents stabilize the small lipophilic droplets dispersed in the aqueous phase.

As emulsifying agents that may be used in the manufacture of beadlets, macro-molecules like hydrocolloids can be applied. Macro-molecules have the advantage that they can additionally stabilize the droplets sterically. The properties of the emulsifying agents have to be chosen properly, in order to achieve the best stabilization of the small lipophilic droplets.

Emulsifying agents that are commonly used in the manufacture of beadlets are gelatins, proteins, starches, pectins, gum acacia, xanthan gum, guar, caroub gums, lignosulfonates, alginates, celluloses, cellulose derivatives, such as carboxymethyl-cellulose, and/or modified polysaccharides.

It is often advantageous to combine said macro-molecular emulsifiers with co-emulsifiers to obtain the desired emulsifying and stabilizing properties with regard to the whole production process of the beadlet itself, i.e. with regard to the different types of emulsions that have to be stabilized, and the final application of the beadlet which may for example be in a beverage or a food product.

If for example gelatin is used as an emulsifier often ascorbyl palmitate is used as co-emulsifier as ascorbic acid esters of a fatty acid have good emulsifying properties and simultaneously act as antioxidants, especially in combination with other antioxidants like alpha-tocopherol.

In order to develop animal free beadlet forms modified food starches are used more and more instead of gelatin. Unfortunately the emulsifying properties of these starches are less powerful than those of gelatin and a well performing combination with a co-emulsifier is unknown, as the combination with ascorbyl palmitate is not suitable, mainly because aqueous solutions of ascorbyl palmitate have a high pH value of more than 7.

It was therefore an objective of the following invention to improve the emulsifying properties of modified starch and to provide a dry (finely divided) pulverous formulation, preferably a beadlet formulation, containing one or more fat-soluble active ingredients wherein the matrix material should be a modified food starch. Furthermore the pulverous formulation should satisfy the usual demands, both during production and in a food composition, such as being stable against oxidation, being and staying evenly distributed in the product over time and so on.

It has surprisingly been found that the objective of the present invention is achieved by a pulverous formulation comprising modified food starch, one or more fat-soluble active ingredients and one or more components chosen from the group consisting of polyglycerol esters.

It was not to be foreseen by the person skilled in the art that a pulverous formulation according to the present invention would solve the above mentioned issues.

The term “modified food starch” as used herein relates to modified starches that are made from starches substituted by known chemical methods with hydrophobic moieties. For example starch may be treated with cyclic dicarboxylic acid anhydrides such as succinic and/or glutaric anhydrides, substituted with an alkyl or alkenyl hydrocarbon group.

A particularly preferred modified starch of this invention has the following formula (I)

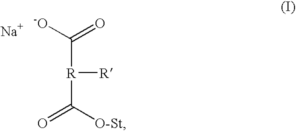

wherein St is a starch, R is an alkylene radical and R′ is a hydrophobic group. Preferably R is a lower alkylene radical such as dimethylene or trimethylene. R′ may be an alkyl or alkenyl group, preferably having 5 to 18 carbon atoms. A preferred modified starch of formula (I) is starch sodium octenyl succinate (“OSA-starch”). The term “OSA-starch” as used herein denotes any starch (from any natural source such as corn, wheat, tapioca, potatoe or synthesized) that was treated with octenyl succinic anhydride (OSA). The degree of substitution, i.e. the number of esterified hydroxyl groups with regard to the total number of hydroxyl groups usually varies in a range of from 0.1% to 10%, preferably in a range of from 0.5% to 5%, more preferably in a range of from 2% to 4%.

OSA-starches may contain further hydrocolloids, such as starch, maltodextrin, carbohydrates, gum, corn syrup etc. and optionally any typical emulsifier (as co-emulgator), such as mono- and diglycerides of fatty acids, polyglycerol esters of fatty acids, lecithins, sorbitan monostearate, plant fiber and/or sugar.

OSA-starches are commercially available e.g. from National Starch under the trade names HiCap 100, Capsul, Capsul HS, Purity Gum 2000, UNI-PURE, HYLON VII; from Roquette Freres; from CereStar under the tradename C*EmCap or from Tate & Lyle.

It is advantageous if the amount of modified food starch(es) (one or more compounds) in the pulverous formulation is in the range of from 30 to 65% by weight, preferably from 40 to 50% by weight, each based on the total weight of the formulation.

The term “polyglycerol ester” as used herein relates to polyglycerol esters of fatty acids. Preferably the polyglycerol moiety mainly consists of di-, tri-, and tetraglycerol with a maximum polymerization degree up to decaglycerol. It is especially preferred if less than 10% of the polyglycerols have a polymerization degree that is equal to or higher than heptaglycerol. The polyglycerol esters according to the present invention are dispersible in water and soluble in oil. Polyglycerol esters with a HLB value of 5 to 8, preferably of 6 to 7 are most preferred. Polyglycerol esters of the present invention are e.g. commercially available from Riken Vitamins under the trade name “Rikemal JV-3081”.

It is advantageous if the amount of polyglycerol esters(s) (one or more compounds) in the pulverous formulation is in the range of from 0.1 to 10% by weight, preferably from 0.5 to 2% by weight, each based on the total weight of the formulation.

According to the present invention it is advantageous if the amount of fat-soluble active ingredient(s) (one or more compounds) is in the range of from 2 to 20% by weight, preferably from 5 to 15% by weight, each based on the total weight of the pulverous formulation.

Antioxidants prevent oxidation of the active ingredients, thus preserving the desired properties of the actives, such as biological activity, color and/or color intensity. According to the present invention fat-soluble and/or water-soluble antioxidants may be used. Preferred water-soluble antioxidants are for example ascorbic acid or salts thereof, preferably sodium ascorbate. Preferred fat-soluble antioxidants are for example tocopherol (synthetic or natural); butylated hydroxytoluene (BHT); butylated hydroxyanisole (BHA); ethoxyquin (EMQ); propyl gallate; tert. butyl hydroxyquinoline. dl-Tocopherol is especially preferred.

According to the present invention it is advantageous if the amount of antioxidant(s) (one or more compounds) is in the range of from 0.1 to 10% by weight, preferably from 0.5 to 3% by weight, each based on the total weight of the pulverous formulation.

Plasticizers are used in order to modulate the mechanical properties of the matrix. Thus flexibility, softness, elasticity, and compressibility can be controlled. According to the present invention preferred plasticizers can be selected from glycerol, mono-, di- and oligosaccharides; sucrose, inverted sucrose, glycerol, sorbitol, glucose (syrup), fructose, lactose, maltose, saccharose, polyethylene glycol, sugar alcohols and starch hydrolysates, such as dextrins and maltodextrins are preferred. Maltodextrins are especially preferred.

According to the present invention it is advantageous if the amount of plasticizers (one or more compounds) is in the range of from 5 to 50% by weight, preferably from 5 to 30% by weight, each based on the total weight of the pulverous formulation.

By an additional step during the formulation, the matrix can also be made hydrophobic, so as to make that the pulverous formulation are no longer water dispersible. This can be achieved by e.g. cross linking the matrix.

In a preferred embodiment of the present invention the pulverous formulation may contain further adjuvants which are preferably selected from triglycerides (oils and/or fats), more preferred from vegetable oils and/or fats, preferably corn oil, sunflower oil, soybean oil, safflower oil, rape seed oil, peanut oil, palm oil, palm kernel oil, cotton seed oil and/or coconut oil, including fractionated qualities thereof. The triglycerides can further preferably be so-called MCT (medium chain triglycerides), i.e. ester of medium chain fatty acids (preferably saturated fatty acids with a chain length of 6 to 12 C atoms) and glycerol.

According to the present invention it is advantageous if the amount of triglyceride(s) (one or more compounds) is in the range of from 1 to 15% by weight, preferably from 2 to 10% by weight, each based on the total weight of the pulverous formulation.

In a preferred embodiment of the process of the present invention one or more flow-conditioning agents (also referred to as anti-caking agents, flow enhancer) are added to the powder, i.e. during the drying step or to the product that is obtained in step d).

Preferred flow-conditioning agents are for example (hydrophilic) fumed silica, such as those commercially available under the trade name AEROSIL® from Degussa.

According to the present invention it is advantageous if the amount of flow-conditioning agent(s) (one or more compounds) in the composition is in the range of from 0.1 to 1% by weight, based on the total weight of the pulverous formulation.

It is advantageous if the residual moisture content in the pulverous formulation obtained by the drying step is in the range of from 1 to 8 weight-% preferably from 1 to 3 weight-%, based on the total weight of the pulverous formulation.

The pulverous formulation of the present invention can be existent in the form of a finely divided powder (with a mean particle size of 0.5-50 μm in diameter), in the from of beadlets (with a mean particle size of 50-1000 μm in diameter) or in the form of granules or a granulate (with a mean particle size of more than 1 mm in diameter). Beadlets are especially preferred.

The present invention is also directed to a composition containing the pulverous formulation according to the present invention, especially to a food composition or a dietary supplement containing the pulverous formulation.

Dietary supplements according to the present invention can preferably be tablets, granules, capsules, pastes, gels, powders, which may further contain excipients commonly known by the person skilled in the art.

According to the present invention a beverage containing the pulverous formulation is an especially preferred food composition. The beverage of the present invention may be a base composition to which upon its use water or another liquid beverage composition (such as milk, buttermilk, soured milk, yogurt (drinks), juice and so on) can or has to be added. The base composition can be prepared as a dry, powder product (instant beverage) which before its consumption is to be mixed with water or another liquid beverage composition, as a concentrate to which water or another liquid beverage composition has to be added, or as a beverage to which no liquid needs to be added. Instant beverages, e.g. in the form of effervescent formulations, are especially preferred.

According to the present invention further examples of preferred food compositions are cereals and bars, e.g. cereal bars, chocolate bars, candy bars, which may besides the pulverous formulation of the invention further contain additional ingredients commonly known by the person skilled in the art, such as nuts, fruit, grains in various forms, coconut, marzipan, marshmallow, caramel, nougat, cookie, toffee, fondant, and/or fudge, said bars often being coated with chocolate.

The invention is further illustrated by the following examples.

### EXAMPLES

23.0 g of crystalline b-carotene, 2.0 g dl-α-tocopherol, 1.0 g polyglycerol ester Rikemal JV-3081, and 11.0 g corn oil are dissolved in an appropriate solvent (oil phase). This solution is added under stirring to a solution of 90.0 g modified food starch, 13.0 g sucrose, and 230.0 g water at 50-60° C.

This pre-emulsion is homogenized with a rotor-stator-homogenizer for 10 minutes. Eventually the emulsion is homogenized with a high pressure homogenizer. In the next step the remaining solvent is removed by distillation and the solvent-free emulsion is dried by a standard powder catch process. 92.4 g of beadlets are obtained with a b-carotene content of 12.1%.

### Beverage (ACE Beverage)

The ACE beverages are prepared by mixing an ACE beverage base (containing juice concentrates, ascorbic acid, orange oil, Vitamin E, water, and the b-carotene product form according to the Example) with sugar syrup, water and sodium benzoate. After filling the beverages in glass bottles, a pasteurization step is performed.

1. Pulverous formulation comprising modified food starch, one or more fat-soluble active ingredients and one or more components chosen from the group consisting of polyglycerol esters.

2. Formulation according to claim 1 characterized in that the modified food starch is starch sodium octenyl succinate.

3. Formulation according to claim 1 characterized in that the amount of modified food starch(es) (one or more compounds) in the formulation is in the range of from 30 to 65% by weight, preferably from 40 to 50% by weight, each based on the total weight of the formulation.

4. Formulation according to claim 1 characterized in that the fat-soluble active ingredient(s) (one or more compounds) are chosen from the group consisting of vitamin A, D, E, K and derivatives thereof; carotenoids; polyunsaturated fatty acids and flavoring and aroma substances.

5. Formulation according to claim 4 characterized in that the fat-soluble active ingredient(s) (one or more compounds) are chosen from the group consisting of carotenoids.

6. Formulation according to claim 5 characterized in that the fat-soluble active ingredient is beta-carotene.

7. Formulation according to claim 1 characterized in that the polyglycerol ester(s) (one or more compounds) are chosen from the group consisting of polyglycerol esters with a maximum polymerization degree up to decaglycerol.

8. Formulation according to claim 1 characterized in that the polyglycerol ester(s) (one or more compounds) are chosen from the group consisting of polyglycerol esters with a HLB value of 5 to 8, preferably of 6 to 7.

9. Formulation according to claim 1 characterized in that the amount of polyglycerol ester(s) (one or more compounds) in the pulverous formulation is in the range of from 0.1 to 10% by weight, based on the total weight of the formulation.

10. Formulation according to claim 1 characterized in that the amount of polyglycerol ester(s) (one or more compounds) in the pulverous formulation is in the range of from 0.5 to 2% by weight, based on the total weight of the formulation.
